(19) United States
(12) Patent Application Publication
(10) Pub. No.: US 2013/0101726 A1
(43) Pub. Date: Apr. 25, 2013

(54) METHOD FOR IMPROVING THE DENSITY OF PELLETED ANIMAL FEEDS

(71) Applicant: Peter VINELLI, Atlanta, GA (US)

(72) Inventor: Peter VINELLI, Atlanta, GA (US)

(73) Assignee: INTERNATIONAL STOCK FOOD CORPORATION, Marietta, GA (US)

(21) Appl. No.: 13/445,359

(22) Filed: Apr. 12, 2012

Related U.S. Application Data
(60) Provisional application No. 61/533,469, filed on Sep. 12, 2011.

(51) Int. Cl. A23K 1/175

(52) U.S. Cl. CPC A23K 1/175
USPC 426/623

(57) ABSTRACT

The present invention relates to methods for improving the durability of pelleted animal feeds, reducing the production of fines from pelleted feeds and for reducing losses during handling after manufacture of pelleted animal feeds that commonly contain a mix of processed grains and optionally fats (both animal and vegetable), proteins (both animal and vegetable) and minerals by the addition of alkali metal or alkaline earth metal sulfite, bisulfite, metabisulfite, sulfate or mixtures thereof.

This application claims benefit to U.S. Provisional Application Ser. No. 61/533,469 filed Sep. 12, 2011, the entire contents of which are incorporated herein by reference.

### FIELD OF THE INVENTION

The present invention relates to a method for improving the durability of pelleted animal feeds that commonly contain a mix of processed grains and optionally fats (both animal and vegetable), proteins (both animal and vegetable) and minerals by the addition of alkali metal or alkaline earth metal sulfite, bisulfite, metabisulfite, sulfate or mixtures thereof.

### BACKGROUND OF THE INVENTION

The use of sulfite containing additives to preserve food by scavenging oxygen has long been known, as described in various issued patents, e.g., U.S. Pat. No. 2,799,583 (Harris), U.S. Pat. No. 2,825,651 (Loo et al), U.S. Pat. No. 3,169,068 (Block) and U.S. Pat. No. 3,284,212 (Tribble).

Prior art uses of sodium metabisulfite for silage preservation purposes, such as is described in the above-noted Harris patent, have primarily been concerned with the preservation of silages through removal of oxygen to inhibit spoilage based on the growth of oxygen-dependent mold or bacteria, as part of a fermentation cycle of fresh harvested forage stored on a farm site.

Harris describes a process for the preservation of silage by the addition of an alkaline metabisulfite and urea. The urea is present to control the corrosivity of the metabisulfites toward ferrous metals used in the construction of silos. The proportion of metabisulfite is said, by Harris, not to be critical and is said to vary from about 0.1 to 1.0%, by weight, or from 2-20 lbs/ton of silage. In such relatively high proportions, the metabisulfite has a strong antibacterial effect on the silage and destroys much of the natural bacteria required for desired fermentation.

On the contrary, as will be described more fully below, the process and compositions of the present invention are concerned with improving the durability of pelleted animal feeds that commonly contain a mix of processed grains. These grains or feed are not intended for a fermentation process of any kind.

U.S. Pat. No. 3,184,314 describes preservation and controlling of fermentation of high moisture content grain silages by the use of compositions comprising (a) an alkali or alkaline earth metal sulfate salt, and (b) an amylolytic enzyme, preferably malt diastase.

U.S. Pat. No. 4,508,737 teaches that superior, fast acting preservation of and fermentation control for various silages and stored grains, especially high moisture content grains, can be provided by use of 0.2-1.5 lbs of alkali metal sulfite, alkali metal bisulfite, alkali metal metabisulfite or mixtures thereof per ton of silage.

In both U.S. Pat. No. 3,184,314 and U.S. Pat. No. 4,508,737, fermentation control was the key factor for adequate preservation of fresh harvested forages on the farm.

U.S. Pat. Nos. 4,775,539, 4,996,065 and 5,378,471 relate to binder compositions of pelleted and compressed animal feeds comprising a mixture of a reactive metal salt and a reactive metal oxide or hydroxide. However, there is no correlation to sodium sulfites and bisulfites used in the present invention.

U.S. Pat. No. 5,786,007 relates to an animal feed binder for use in forming pellets. The binder is an anhydrous complex salt which contains a major portion of magnesium sulfite and a minor portion of magnesium sulfate. However, there are major differences between magnesium sulfite and the sulfites and sulfates of the present invention. For example, magnesium sulfite becomes insoluble if the pH is increased above 4.0 and it can not be used in the present methods.

U.S. Pat. No. 6,610,341 describes preservation of animal feed by adding from about 0.1 to 2 lbs/ton of processed grain, of an alkali metal or alkaline earth metal sulfite, bisulfite, metabisulfite or mixtures thereof. However, there is no mention of pelleting or of pelleted feeds.

Surprisingly, it has now been found that improved durability of pelleted animal feeds, particularly commercially manufactured animal feeds, such as cattle feed, horse feed, small animal feed, and swine feed, which commonly contain a mix of processed grains and optionally fats (both animal and vegetable), proteins (both animal and vegetable) and minerals can be achieved by applying the compositions of this invention during the manufacturing process, prior to the pelleting process.

It is an object of the invention to provide a method for improving the durability of pelleted animal feed.

Another object of the invention is to provide a method for reducing the production of fines from pelleted animal feed.

Another object of the invention is to provide a method for reducing food losses during handling after manufacture of pelleted animal feed.

### SUMMARY OF THE INVENTION

The invention relates to the durability, and improvement thereof, of pelleted animal feeds that commonly contain a mix of processed grains and optionally fats (both animal and vegetable), proteins (both animal and vegetable) and minerals.

More specifically the present invention relates to a method for improving the durability of pelleted animal feed which comprises mixing a compound selected from the group consisting of alkali metal or alkaline earth metal sulfite, bisulfite, metabisulfite, sulfates and mixtures thereof with processed grains prior to pelleting.

Another aspect of the present invention is a method for reducing the production of fines from pelleted animal feed which comprises mixing a compound selected from the group consisting of alkali metal or alkaline earth metal sulfite, bisulfite, metabisulfite, sulfates and mixtures thereof with processed grains prior to pelleting.

Another aspect of the present invention is a method for reducing food losses during handling after manufacture of pelleted animal feed which comprises mixing a compound selected from the group consisting of alkali metal or alkaline earth metal sulfite, bisulfite, metabisulfite, sulfates and mixtures thereof with processed grains prior to pelleting.

In another aspect of the present invention the amount of the compound selected from the group consisting of alkali metal or alkaline earth metal sulfite, bisulfite, metabisulfite, sulfates and mixtures thereof is in the range of 0.1 to 10 lbs/ton of processed grains.

In another aspect of the present invention, the amount of the compound selected from the group consisting of alkali metal or alkaline earth metal sulfite, bisulfite, metabisulfite, sulfates and mixtures thereof is in the range of 0.1 to 4.5 lbs/ton of processed grains.

In another aspect, the amount of the compound selected from the group consisting of alkali metal or alkaline earth metal sulfite, bisulfite, metabisulfite, sulfates and mixtures thereof is in the range of 0.1 to 4.0 lbs/ton of processed grains.

In another aspect, the amount of the compound selected from the group consisting of alkali metal or alkaline earth metal sulfite, bisulfite, metabisulfite, sulfates and mixtures thereof is in the range of 0.2 to 4.0 lbs/ton of processed grains.

In another aspect, the amount of the compound selected from the group consisting of alkali metal or alkaline earth metal sulfite, bisulfite, metabisulfite, sulfates and mixtures thereof is in the range of 0.1 to 2.0 lbs/ton of processed grains.

In another aspect, the compound is an alkali metal or alkaline earth metal sulfite, bisulfite or metabisulfite in the amount of 0.1 to 4.0 lbs/ton of processed grain.

In another aspect, the compound is an alkali metal or alkaline earth metal sulfite, bisulfite or metabisulfite in the amount of 0.1 to 2.0 lbs/ton of processed grain.

In another aspect, the compound is a sulfate selected from an alkali metal or alkaline earth metal sulfate in the amount of 0.2 to 4.0 lbs/ton of processed grains.

### BRIEF DESCRIPTION OF THE DRAWINGS

FIG. 1 shows the mean PDI of each of the treatments in Trial 1.

FIG. 2 shows that the PDI of the feeds treated with the inventive composition were significantly higher than the non-treated feed (P<0.001) in Trial 1.

FIG. 3 shows that the PDI of the feeds treated with the inventive composition were significantly higher than the non-treated feed (P<0.001) in Trial 2.

FIG. 4 shows the statistics of both Dairy Concentrate Pellets.

FIG. 5 shows that the PDI of feeds treated with 2 lbs of COMP showed a significant improvement (P<0.005).

FIG. 6 shows that the PDI of feeds treated with 2 lbs of COMP showed a significant improvement (P<0.001).

### DETAILED DESCRIPTION OF THE INVENTION

Pelleted feeds are manufactured for animals so that the animal consumes a desirable blend of grains, fats, proteins, minerals, etc., in a ratio that is dictated by the livestock producer or animal nutritionist. Consumption of pellets assures that the animal is getting the appropriate nutrition needed to maximize feed efficiency. However, pellets often begin to break apart during transport, bagging, and handling by both the feed manufacturer (including dealers) and the livestock producer. The breakdown of these pellets, known in the industry as fines, is a source of lost feed and decreased nutrition to the animals.

Durability of feeds indicate their ability to withstand handling and is one of the most important characteristics of pelleted feed. Poor durability results in the generation of fines. Studies with swine have shown that pelleted feeds with 10 to 15 percent fines can negatively influence animal performance. As the fines content increases, feed wastage, low palatability, and lower feed conversion ratios can occur. Fines also create waste at the feeder and are not as palatable as whole pellets. Factors that can affect the production of fines include mean particle size, diet formulation and starch gelatinization. Also, high fiber diets tend to produce more fines than high starch diets, since these ingredients have different binding abilities.

Improving the durability of the pellet directly reduces these losses as the pellets will be less likely to break down and produce fines.

Improvement of the durability of pellets can be determined based on the Pellet Durability Index (PDI), which can be used as an indication of how well pellets hold their integrity during packing and handling. An increase in pellet durability is a result of increased pellet density. Durability and density are terms that are often used interchangeably in the industry.

The present composition achieves improved pellet durability in a uniquely effective way by adding from about 0.1 to 10 lbs/ton of a mix of processed grains and optionally fats (both animal and vegetable), proteins (both animal and vegetable) and minerals prior to the pelleting process of an alkali metal or alkaline earth metal sulfite, bisulfite, metabisulfite, sulfates or mixtures thereof. If the amount is below about 0.05 lbs/ton, the effect is inadequate to produce the desired density. Sulfite and sulfate amounts at the lower end of the range have been found particularly effective with a sulfite or sulfate amount of 0.1 to 2.0 lbs/ton pelleted feeds. More particularly with a sulfite or sulfate amount of 0.1 to 2.0 lbs/ton pelleted feeds. Most preferred is a sulfite amount of 0.1 to 2.0 lbs/ton pelleted feed.

Examples of alkali metal or alkaline earth metal sulfites include, but are not limited to, sodium, potassium and ammonium sulfites, bisulfites and metabisulfites. Sodium sulfite and sodium bisulfite are preferred.

Examples of alkaline metal or alkaline earth metal sulfates include, but are not limited to sodium, potassium and ammonium sulfates, bisulfates and metabisulfates.

While the method of the invention may be practiced solely using alkali metal or alkaline earth metal sulfite, bisulfite, metabisulfite, sulfates or mixtures thereof, the best results are obtained by using compositions comprising such compounds together with other additives.

The preferred compositions of the present invention comprise the following ingredients in the indicated amounts:

| Constituent | Amount |
|---|---|
| (a) alkali metal or alkaline | 0.1 to 4 lbs/ton of pelleted |
| earth metal sulfite, bisulfite | feed |
| or metabisulfite | |
| (b) alkali metal or alkaline | 0.2 to less than 4 lbs/ton |
| earth metal sulfate | pelleted feed |

Pellets are produced by conventional means. For example, all ingredients are measured and blended in a mixing bin. The mixture is sent to a conditioner where water and steam are added prior to putting the mixture in the pelleting machine.

The compositions may be applied directly to the pellet ingredients prior to the pelleting process. The compositions may be applied in any known manner practical for production runs; as for example, by preparing the composition in a liquid aqueous solution and spraying the solutions or formulating the composition in dry granular form and applying during the stage where the ingredients are mixed in the bin prior to pelleting.

In one aspect of the invention, the alkali metal or alkaline earth metal sulfite, bisulfite or metabisulfite or alkali metal or alkaline earth metal sulfate should be applied to processed grains and/or total feed mixes with preferably additional inorganic sulfate, especially when the composition is formulated in a dry form. In its liquid form, the composition should include an alkaline base chemical as well, such as sodium hydroxide or potassium hydroxide, when it is desirable to neutralize the pH. However, sodium hydroxide and potassium hydroxide are not active ingredients or used in the dry formulation of the present invention. A preferred liquid formulation comprises 0.23-0.25 lbs of sodium bisulfite per pound of the composition, 0.04-0.05 lbs of potassium hydroxide and 70-73% water. A preferred dry formulation comprises 0.6-0.70 sodium sulfate lbs per pound of the composition and 0.2-0.3 lbs of sodium sulfite per pound of the composition.

The processed grains may be steam-flaked grain, steam-rolled grain, de-hulled grain, cracked grain, crimped grain, ground grain or by-products thereof.

The particular inorganic sulfate employed is not critical to the present invention. Examples of the inorganic sulfate include sodium sulfate, sodium bisulfate, potassium sulfate, potassium bisulfate, magnesium sulfate, magnesium bisulfate, and ammonium sulfate, ammonium bisulfate, preferably sodium sulfate, sodium bisulfate, alkali metal sulfite, bisulfite, metabisulfite, sodium sulfite or sodium bisulfite.

The amount of inorganic sulfate which can be employed in the present invention ranges from 20%-90% of the composition or 0.2 to 3.6 lbs/ton of processed gain preferably 0.5 to 0.7 lbs/ton of processed grain. In an exemplary embodiment the processed grain is steam-flaked or steam-rolled grain.

In addition, surfactants, such as formalin, may also be added to the processed grain and/or total feed mixes. Any other suitable non-toxic surfactant, preferably dimethyl polysiloxane to help wetting and spreading of the composition throughout the grain or feed mix can also be used. Anionic, cationic amphoteric, and non-ionic surfactants have all proved useful. Examples of suitable surfactants which may be used include, but are not limited to, sodium alkylsulfonethanolamine, dimethylpolysiloxane ammonium alkylarylpolyether-sulfonate, sodium alkylarylpolyethersulfonate, solfonated fatty acids and lignin sulfonate and its salts.

The grain which forms the processed grain is not critical to the present invention. Examples of suitable grains include corn, oats, barley, rice, rye, soybeans, sorghum, triticale, and grain seeds such as, sunflower, canola, flaxseed, rapeseed, safflower, sesame. The grain may be raw, steam-flaked grain or steam-rolled grain.

The following examples are provided for illustrative purposes and are in no way intended to limit the scope of the invention.

### Example 1

### Procedures:

6 samples were taken at random for each treatment after feed left the cooler prior to bagging or being loaded bulk.
500 g samples were taken and run in the Seedburo Pellet Durability Tester (developed by Kansas State University).
   500 gram samples of screened pellets were run in the PDI tester for 10 minutes.
   Samples were re-screened and whole pellets were weighed.
   PDIs were determined by dividing the weight of pellets post-tumbling by 500 and then multipyling by 100.

### Trial 1: —Commercial 38% Protein Concentrate Pellet

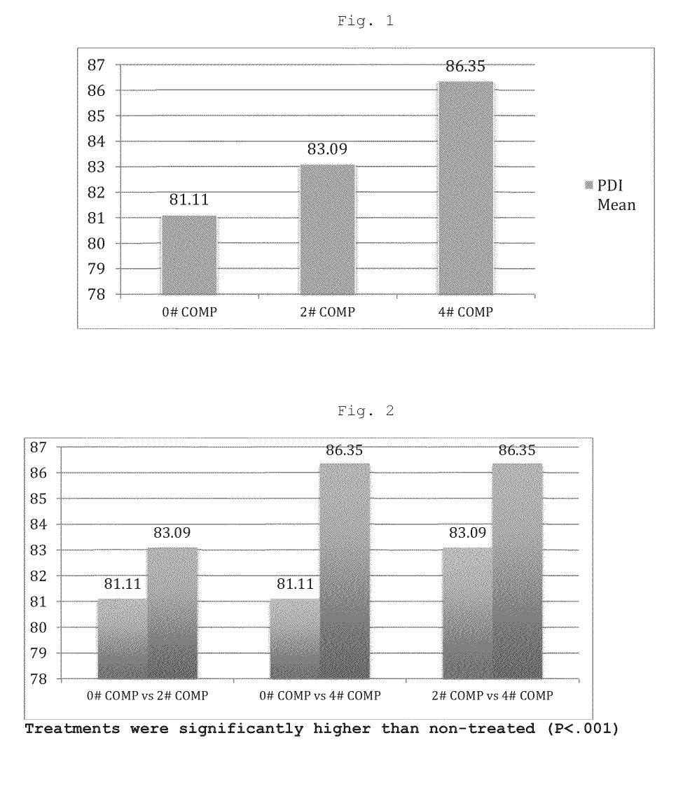

FIG. 1 and FIG. 2 show the results of the treatments using the composition of the invention (COMP) in the PDI study with 38% protein concentrate pellets.
10 lbs of AMERI-BOND 2X per ton
10 lbs of AMERI-BOND 2X per ton plus 2 lbs of COMP per ton
10 lbs of AMERI-BOND 2X per ton plus 4 lbs of COMP per ton

The composition (COMP) of the invention used contained 64.4% sodium sulfate, 28.5% sodium sulfite per pound of the composition, flavor, potassium sulfate and bentonite.

FIG. 1 shows the mean PDI of each of the treatments above.

FIG. 2 shows that the PDI of the feeds treated with the inventive composition are significantly and unexpectedly higher than the non-treated feed.

### Trial 2—Custom Dairy Concentrate Pellet

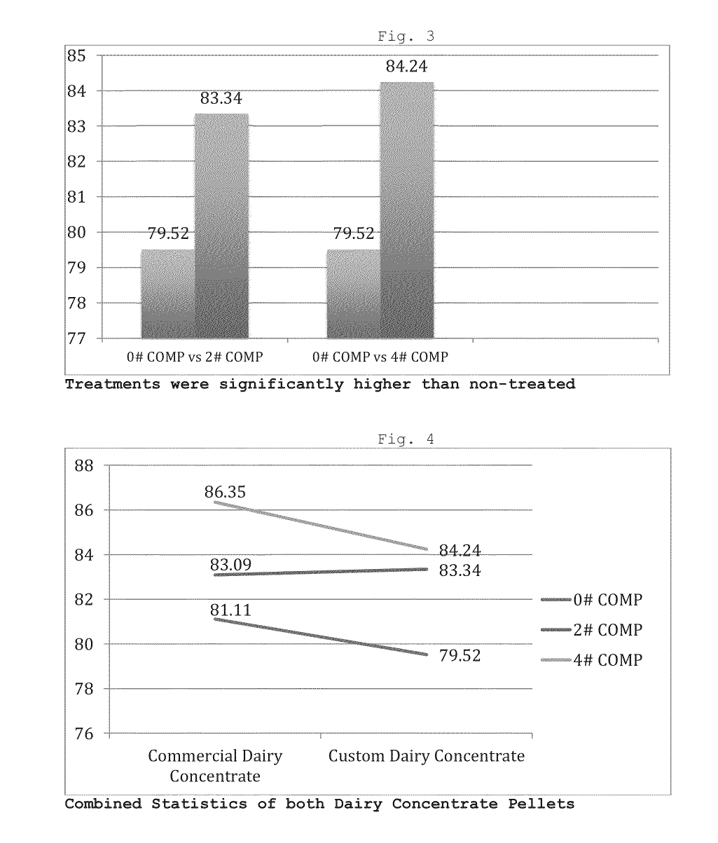

FIG. 3 and FIG. 4 show the results of the treatments using the composition of the invention (COMP) in the PDI study with custom dairy concentrate pellets.

10 lbs of AMERI-BOND 2X per ton

10 lbs of AMERI-BOND 2X plus 2 lbs of COMP per ton

10 lbs of AMERI-BOND 2X plus 4 lbs of COMP per ton

FIG. 3 shows that the PDI of the feeds treated with the inventive composition are significantly and unexpectedly higher than the non-treated feed.

### Statistical Analysis of Combined Trials

PDIs of feeds treated with 2 lbs of COMP plus 10 lbs of Ameri-Bond 2X are significantly higher than feeds treated with no COMP and 10 lbs of AMERI-BOND 2X (P<0.001).
PDIs of feeds treated with 4 lbs of COMP plus 10 lbs of AMERI-BOND 2X are significantly higher than feeds treated with no COMP and 10 lbs of AMERI-BOND 2X (P<0.001)
PDIs of feeds treated with 4 lbs of COMP and 10 lbs of AMERI-BOND 2X are significantly higher than feeds treated with 2 lbs of COMP plus 10 lbs of AMERI-BOND 2X.

### Example 2

Feeds with varying sizes (⅛″ pellet vs ¾″ cubes) and varying amounts of AMERI-BOND 2X pellet binder.

The following feeds were used in the comparison:
1. Commercial deer pellet (18% protein, 15 lbs of AMERI-BOND 2X)
2. Commercial range cube (24% protein, 10 lbs of AMERI-BOND 2X)
3. Commercial range cube (20% protein, no AMERI-BOND 2X)
   Deer Pellet Treatments (18% Pellet ⅛″)

15 lbs of AMERI-BOND 2X per ton

15 lbs of AMERI-BOND 2X per ton plus 2 lbs of COMP

15 lbs of AMERI-BOND 2X per ton plus 4 lbs of COMP.

Range Cube Treatments (24% Cube ¾″)

10 lbs of AMERI-BOND 2X per ton

10 lbs of AMERI-BOND 2X per ton plus 2 lbs of COMP

10 lbs of AMERI-BOND 2X per ton plus 4 lbs of COMP.

### Range Cube Treatments (20%)

No pellet binder and no COMP

No pellet binder and 2 lbs of COMP

No pellet binder and 4 lbs of COMP.

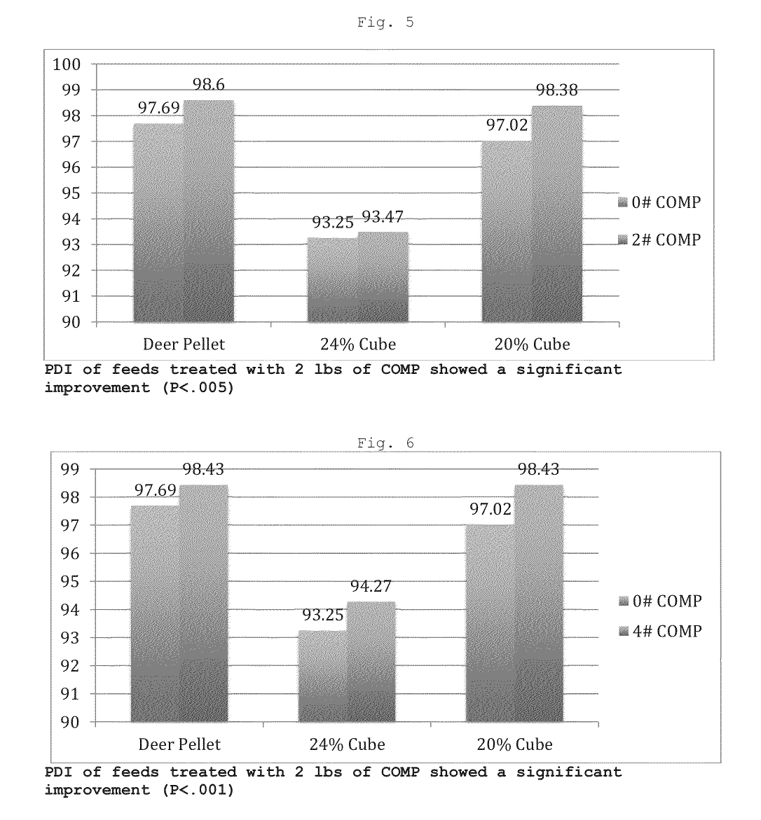

In this example, all pellets had a high PDI prior to the addition of the inventive composition. The results in FIG. 5 and FIG. 6 show further improved PDI with a statistical significance due to the inventive composition. Additionally, improved PDI is achieved even when no binder is used such as the range cubes employed in Example 2. Thus, the present invention is effective with or without the use of pellet binders.

While the invention has been described in detail and with reference to specific embodiments thereof, it will be apparent to one skilled in the art that various changes and modifications can be made therein without departing from the spirit and scope thereof.

We claim:

1. A method for improving durability of pelleted animal feed comprising
mixing a compound selected from the group consisting of an alkali metal or alkaline earth metal sulfite, bisulfite, metabisulfite, sulfates and mixtures thereof with processed grains prior to pelleting,
wherein the amount of said compound is in the range of 0.1 to 10 lbs/ton of processed grains.

2. The method according to claim 1, wherein the amount of said compound is in the range of 0.1 to 4.5 lbs/ton of processed grains.

3. The method according to claim 1, wherein the amount of said compound is in the range of 0.1 to 4.0 lbs/ton of processed grains.

4. The method according to claim 1, wherein the amount of said compound is in the range of 0.2 to 4.0 lbs/ton of processed grains.

5. The method according to claim 1, wherein the amount of said compound is in the range of 0.1 to 2.0 lbs/ton of processed grains.

6. The method according to claim 1, wherein said compound is an alkali metal or alkaline earth metal sulfite, bisulfite or metabisulfite.

7. The method according to claim 6, wherein said compound is in the amount of 0.1 to 4.0 lbs/ton of processed grain.

8. The method according to claim 6, wherein said compound is in the amount of 0.1 to 2.0 lbs/ton of processed grain.

9. The method according to claim 1, wherein said compound is a sulfate selected from an alkali metal or alkaline earth metal sulfate.

10. The method according to claim 9, wherein said compound is in the amount of 0.2 to 4.0 lbs/ton of processed grains.

11. A method for reducing the production of fines from pelleted animal feed comprising
mixing a compound selected from the group consisting of an alkali metal or alkaline earth metal sulfite, bisulfite, metabisulfite, sulfates and mixtures thereof with processed grains prior to pelleting,
wherein the amount of said compound is in the range of 0.1 to 10 lbs/ton of processed grains.

12. The method according to claim 11, wherein the amount of said compound is in the range of 0.1 to 4.5 lbs/ton of processed grains.

13. The method according to claim 11, wherein the amount of said compound is in the range of 0.1 to 4.0 lbs/ton of processed grains.

14. The method according to claim 11, wherein the amount of said compound is in the range of 0.2 to 4.0 lbs/ton of processed grains.

15. The method according to claim 11, wherein the amount of said compound is in the range of 0.1 to 2.0 lbs/ton of processed grains.

16. The method according to claim 11, wherein said compound is an alkali metal or alkaline earth metal sulfite, bisulfite or metabisulfite.

17. The method according to claim 16, wherein said compound is in the amount of 0.1 to 4.0 lbs/ton of processed grain.

18. The method according to claim 16, wherein said compound is in the amount of 0.1 to 2.0 lbs/ton of processed grain.

19. The method according to claim 16, wherein said compound is an alkali metal or alkaline earth metal sulfate.

20. The method according to claim 16, wherein said compound is in the amount of 0.2 to 4.0 lbs/ton of processed grains.

21. A method for reducing food losses during handling after manufacture of pelleted animal feed comprising
mixing a compound selected from the group consisting of an alkali metal or alkaline earth metal sulfite, bisulfite, metabisulfite, sulfates and mixtures thereof with processed grains prior to pelleting,
wherein the amount of said compound is in the range of 0.1 to 10 lbs/ton of processed grains.

22. The method according to claim 21, wherein the amount of said compound is in the range of 0.1 to 4.5 lbs/ton of processed grains.

23. The method according to claim 21, wherein the amount of said compound is in the range of 0.1 to 4.0 lbs/ton of processed grains.

24. The method according to claim 21, wherein the amount of said compound is in the range of 0.2 to 4.0 lbs/ton of processed grains.

25. The method according to claim 21, wherein the amount of said compound is in the range of 0.1 to 2.0 lbs/ton of processed grains.

26. The method according to claim 21, wherein said compound is an alkali metal or alkaline earth metal sulfite, bisulfite or metabisulfite.

27. The method according to claim 26, wherein said compound is in the amount of 0.1 to 4.0 lbs/ton of processed grain.

28. The method according to claim 26, wherein said compound is in the amount of 0.1 to 2.0 lbs/ton of processed grain.

29. The method according to claim 26, wherein said compound is an alkali metal or alkaline earth metal sulfate.

30. The method according to claim 26, wherein said compound is in the amount of 0.2 to 4.0 lbs/ton of processed grains.
